(19) United States
(12) Patent Application Publication
(10) Pub. No.: US 2012/0095245 A1
(43) Pub. Date: Apr. 19, 2012

(54) BIOFUEL PRODUCTION FROM ALGAE

(75) Inventors: Christoper Don Lane, Shaker Heights, OH (US); Andrew Keith Swanson, Clevelanh Heights, OH (US); Aaron Bradford Brister, Clevelanh Heights, OH (US); Thomas F.C. Allnutt, Glenwood, MD (US)

(73) Assignee: Phycal, Inc., Highland Heights, OH (US)

(21) Appl. No.: 13/319,743

(22) PCT Filed: May 11, 2010
(86) PCT No.: PCT/US10/34339

§ 371 Date: Nov. 10, 2011

Related U.S. Application Data
(62) Division of application No. 61/177,101, filed on May 11, 2009.

(51) Int. Cl. C11B 1/10; B06B 1/00

(52) U.S. Cl. 554/8; 422/127

(57) ABSTRACT

The use of acoustic focusing together with a non-destructive extraction process for obtaining lipids from oleaginous algae is described. Acoustic focusing can be used to concentrate oleaginous algae before they are subjected to non-destructive extraction, or acoustic focusing can be used as part of the non-destructive extraction process itself by moving the algae from the algae culture to the extracting solvent. The use of acoustic focusing for removing extraneous particulate matter from algae cultures is also described, as well as the use of non-destructive extraction for controlling levels of algae predators.

### CONTINUING APPLICATION DATA

This application claims the benefit of U.S. Provisional Application Ser. No. 61/177,101, filed May 11, 2009, the disclosure of which is incorporated by reference herein.

### BACKGROUND

The price of petroleum has fluctuated dramatically, reaching record highs of greater than US $140 per barrel in 2008. In part, those price increases reflected economic, political and supply chain uncertainties. Political concerns about the availability of petroleum supplies have led to the realization that energy independence for the US is of critical strategic importance, both economically and militarily. There also is general agreement that the release of CO₂ from fossil fuel combustion contributes substantially to global warming and climate change and must be reduced. As a result of these concerns, the domestic production of biofuels has become an increasingly attractive alternative to the consumption of foreign fossil fuels.

Extraction of hydrophobic products from organisms in aqueous culture traditionally requires that the organisms be dewatered to reduce the overall volume and improve the extraction efficiency of the process. A number of different systems for lipid production, such as in oleaginous yeast, algae, fungi, and bacteria, could benefit from improved extraction methods for lipid and other hydrophobic products (e.g., sterols and secondary metabolites) extraction that do not require exhaustive dewatering of the culture prior to extraction. This is especially applicable to extraction of lipid from microalgae where biomass densities in culture are very low (on the order of 0.5-3 g/L). US Patent Publication 2009/0181438 by Richard A. Sayre and the Ohio State University seeks to solve this through a non-destructive extraction process (herein referred to as “NDEP”). This NDEP process utilizes solvents that are biocompatible. This can be seen in their high (>6) log P_{octanol} values, which reflect the hydrophobicity of a compound.

A number of systems have been developed recently for non-destructive extraction of valuable products and/or lipids from algae. A Dutch team was able to non-destructively extract carotenoids from the halophilic green alga Dunaliella salina using dodecane (Hejazi et al., Biotech Bioeng., 79, p. 29-36 (2002); Hejazi et al., Biotechnol Bioeng., 88, p. 593-600 (2004)). Their process for extraction of carotenoids was described in US Patent Publication No. 2005/0203321. However, they did not use sonic energy or energetic mixing in their extraction process nor did they extract oil. A recently reported process developed by the US Department of Energy Ames Laboratory and Iowa State University is reported to use nanoparticles to non-destructively remove oil from plant cells (Ricketts, Green. Venturebeat.com, Apr. 7, 2009).

“Acoustic standing wave” and “ultrasonic standing wave” (USW) technologies are one and the same and have been recognized as a way to manipulate cells and particles in solution. Hawkes and colleagues described the use of USW energy as a “filter” to clarify yeast cultures to concentrate 5 μm yeast cells some 1000 fold. See Hawkes & Coakley, Sensors and Actuators B75, p. 213-222 (2001). They used the same technology to concentrate latex beads ranging in size from 1.5 to 25 μm. This was done on a continuous basis under USW with liquids moving in a laminar flow. Their prototype USW filter was 126×30×50 mm, with no real limits placed on the size achievable for scale up. In a more recent study, their team constructed a microfluidic device of silicon and glass that they equated with a centrifugal separator. See Harris et al., Sensors & Actuators, B95, p. 425-434 (2003). This technology was not limited to the separation of cells with strong cell walls and inert particles alone since it was later applied to lipid droplets and erythrocytes, as described by Petersson et al., Lab Chips, 5, p. 20-22 (2005). Another report demonstrated that this technology could be used for separation of liquid drops, gas bubbles in liquids, and cylindrical liquid bridges depending on the characteristic wavelength applied. See Marston et al., Ann NY Acad Sci, 1027, p. 414-434 (2004). The use of USW in laminar flow as a method for sheathless concentration of cells for fluorescence activated cell sorting has also been described in U.S. Pat. No. 7,340,957, issued to Kaduchak et al.

Improved methods for extraction of lipid from organisms in cell culture are necessary to improve the quality of the lipid and the economic utility of the processes. Such methods would be equally relevant for any hydrophobic component that is produced in these cells. This is especially true for low density cultures if methods can be employed to bypass the need to dewater by traditional means (e.g., centrifugation and filtration), which are high cost and labor intensive.

### SUMMARY OF THE INVENTION

Non-destructive extraction, as described herein, would serve the goals identified above. Combined with ultrasonic standing wave technology (USW) the NDEP provides a continuous method to concentrate and then expose cells to the solvent in a form that provides improved extraction of the lipid or other hydrophobic compound.

The present invention provides methods of extracting lipids from oleaginous algae that include the use of ultrasonic standing wave technology, as well as the use of a non-destructive extraction process for control of algae predators and algae competitors. Accordingly, in one aspect the present invention provides a method of concentrating and extracting lipid from oleaginous algae in an algae culture that includes providing a portion of algae culture including an oleaginous algae from an algae culture source; concentrating the oleaginous algae by acoustic focusing; mixing the concentrated oleaginous algae with a lipid-extracting solvent to form an algae-solvent mixture; and separating the solvent-algae mixture to obtain a solvent-lipid fraction and an extracted algae fraction. In some embodiments, this method further includes returning the extracted algae fraction to the algae culture source.

In another aspect, the present invention provides a device for extracting lipid from an oleaginous algae that includes a container defining a liquid flowpath therein; a first acoustic focusing device in operative relationship with a first treatment zone in the flowpath; a second acoustic focusing device in operative relationship with a second treatment zone in the flowpath, the second treatment zone being spaced from the first treatment zone; algae flow means for directing the flow of a liquid algae culture including an oleaginous algae along the flowpath; and solvent flow means for directing the flow of a lipid-extracting solvent along the flowpath in a manner so that the liquid algae culture and the lipid-extracting solvent contact one another without substantial mixing. The first acoustic focusing device of the apparatus is structured to cause the oleaginous algae to move out of the liquid algae culture and into the lipid-extracting solvent in the first treatment zone for extracting lipid from the oleaginous algae, thereby releasing lipid into the lipid extracting solvent and converting the oleaginous algae to extracted algae. The second acoustic focusing device of the apparatus is structured to cause extracted algae to move out of the lipid-extracting solvent and back into the liquid algae culture in the second treatment zone.

In another aspect, the invention provides a method of extracting lipid from an oleaginous algae using acoustic focusing that includes providing a flow of a liquid algae culture including oleaginous algae that is in contact with but does not substantial mix with a flow of a lipid-extracting solvent; applying acoustic energy from a first acoustic focusing device to move the oleaginous algae from the flow of liquid algae culture into the flow of lipid-extracting solvent, allowing the oleaginous algae to remain in the lipid-extracting solvent for an amount of time sufficient for the lipid-extracting solvent to extract the lipid thereby converting the oleaginous algae into extracted algae; applying acoustic energy from a second acoustic focusing device to move the extracted algae from the lipid-extracting solvent to the flow of liquid algae culture; and collecting the lipid-extracting solvent that includes the extracted lipid.

Finally, a method of reducing the levels of algae predators and/or algae competitors in an algae culture of a target algae species is provided that includes mixing at least a portion of the algae culture with a lipid-extracting solvent to obtain a solvent-algae mixture; separating the solvent-algae mixture to obtain a solvent-lipid fraction and an extracted algae fraction that includes a decreased level of algae predators and/or algae competitors and a relatively unaffected level of target algae species; and returning the extracted algae fraction to the algae culture.

### BRIEF DESCRIPTION OF THE FIGURES

The present invention may be more readily understood by reference to the following drawings wherein:

FIG. 1 provides a schematic view of a method for concentrating algae cells by acoustic focusing and then using non-destructive extraction to remove algae from the cells using a biocompatible solvent and sonication.

FIG. 2 provides a schematic view showing an apparatus for sonically controlled mixing of algae with solvent in which the solvent runs through the axial region of the apparatus and the liquid algae culture runs through the outer region of the apparatus.

FIG. 3 provides a schematic view showing an apparatus for sonically controlled mixing of algae with solvent in which the liquid algae culture runs through the axial region of the apparatus and the solvent runs through the outer region of the apparatus

FIG. 4 provides a schematic view of an apparatus for extracting lipids from oleaginous algae in which particles of a variety of different sizes are moved by acoustic focusing to a point where they can be collected and removed.

FIG. 5 provides a bar graph showing percentage survival of common salt and freshwater algal predators (grazers) and competitors upon being subjected to the non-destructive extraction process (NDEP).

To illustrate the invention, several embodiments of the invention will now be described in more detail. Reference will be made to the drawings, which are summarized above. Reference numerals will be used to indicate parts and locations in the drawings. The same reference numerals will be used to indicate the same parts or locations throughout the drawing unless otherwise indicated. Skilled artisans will recognize the embodiments provided herein have many useful alternatives that fall within the scope of the invention.

### DETAILED DESCRIPTION OF THE INVENTION

The disclosed embodiments of the present invention are in the field of devices, processes, and systems for improved extraction of useful products from cells in culture without loss of culture viability.

### Definitions

Unless otherwise defined, all technical and scientific terms used herein have the same meaning as commonly understood by one of ordinary skill in the art to which this invention pertains. In case of conflict, the present specification, including definitions, will control.

The terminology as set forth herein is for description of the embodiments only and should not be construed as limiting of the invention as a whole. Unless otherwise specified, “a,” “an,” “the,” and “at least one” are used interchangeably. Furthermore, as used in the description of the invention and the appended claims, the singular forms “a”, “an”, and “the” are inclusive of their plural forms, unless contraindicated by the context surrounding such. The singular “alga” is likewise intended to be inclusive of the plural “algae.”

The terms “comprising” and variations thereof do not have a limiting meaning where these terms appear in the description and claims.

Also herein, the recitations of numerical ranges by endpoints include all numbers subsumed within that range (e.g., 1 to 5 includes 1, 1.5, 2, 2.75, 3, 3.80, 4, 5, etc.).

It is understood that all spatial references, such as “horizontal,” “vertical,” “top,” “upper,” “lower,” “bottom,” “left,” and “right,” are for illustrative purposes only and can be varied within the scope of the disclosure.

The term biocompatible, as used herein, refers to a material that will not adversely affect the growth of algae in the algae culture if the material is left in contact with the algae culture for an extended period. It is recognized by one skilled in the art that all solvents will have some effect on the cultures. In this context biocompatible implies that any effect will not be detrimental to the overall production process (e.g., some portion of the culture is killed but it does not unduly burden the economics of the process)

Laminar flow, as defined herein, refers to fluid that flows in parallel layers, with no disruption between the layers. Laminar flow is a flow regime characterized by high momentum diffusion and low momentum convection. It is the opposite of turbulent flow. In nonscientific terms laminar flow is “smooth,” while turbulent flow is “rough.”

Using a variety of methods exemplary embodiments of the invention are directed at improving the non-destructive extraction of hydrophobic materials from cells. This is particularly applicable to microalgal cells cultured for biofuel production and removal of lipids and fatty acids from these cells without rendering the culture non-viable.

### Acoustic Focusing or Ultrasonic Standing Wave Technology (USW)

The present invention provides various methods and devices for combining ultrasonic standing wave technology with the non-destructive extraction process. This aspect of the invention uses ultrasonic standing wave technology as an injection system and can, by tuning the ultrasonic standing wave (USW) system appropriately, provide better lipid extraction. Ultrasonic standing wave technology provides a number of potential advantages when used in combination with non-destructive extraction, such as the ability to concentrate the oleaginous algae, remove extraneous particulate matter, provide sonication to facilitate the extraction, and provide a rapid and efficient extraction process that can decrease solvent waste.

Prior to extraction, USW focusing of cells can be used as a way to divert/isolate fatty/mature cells from the immature/low fat daughter cells, only extracting a mature cell stream for extraction. This would benefit the extraction rates, reduce extraction volumes and probably benefit overall growth rates of ponds. Such a system concentrates the cells and reduces the need for solvents in the system which will be a major cost factor in the process. Additionally, the acoustic focusing system can be tuned to remove the need for a sonicator for optimal extraction of solvent in the non-destructive extraction process. Dewatering is a costly step and for that reason it is only undertaken at need. The non-destructive extraction process is one step toward removing the need to completely dry the algae prior to extraction. For example, this invention allows the process to concentrate and solvent-extract in a single step, reducing the cost of the process significantly.

In one aspect of the invention, ultrasonic standing wave technology is used to concentrate oleaginous algae prior to extraction. This provides the advantage of minimizing the amount of aqueous algae culture solution that is mixed with the lipid-extracting solvent by concentrating the oleaginous algae within the algae culture. Accordingly, this aspect of the invention provides a method of concentrating and extracting lipid from oleaginous algae in an algae culture.

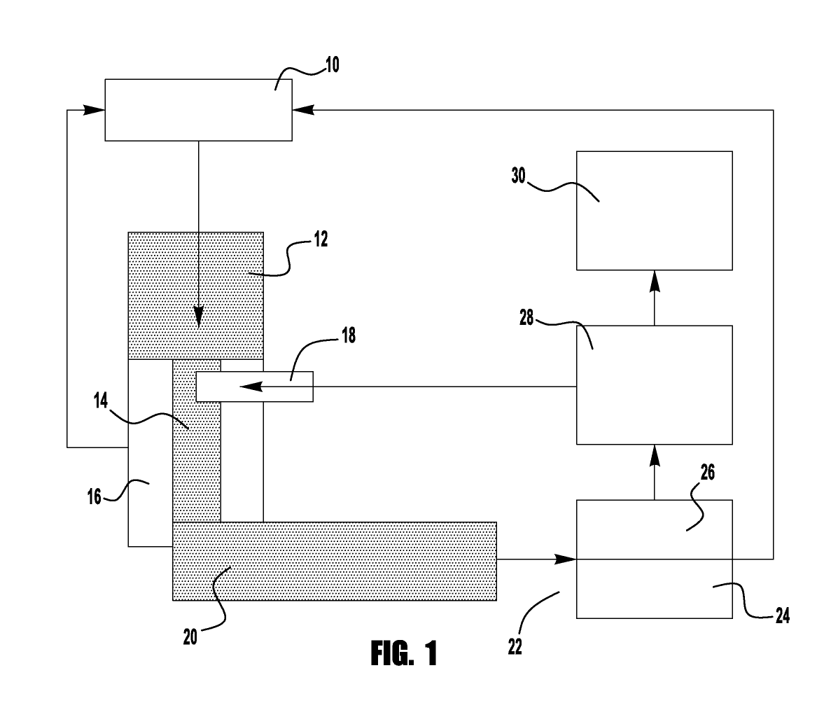

A schematic representation of the process for concentrating oleaginous algae and then extracting the algae using non-destructive extraction is shown in FIG. 1. First, a portion of an algae culture of oleaginous algae cells is obtained from an algae source 10. The algae culture is then treated with an acoustic focusing device 12 that forms a standing wave to focus the cells and concentrate them. The algae culture leaves the acoustic focusing device 12 as two streams; a stream of concentrated algae cells 14 and depleted algae culture medium 16 that has had most of the oleaginous algae cells removed by acoustic focusing. The depleted algae culture medium 16 is then returned to the algae culture source 10. A lipid-extracting solvent is then introduced into the concentrated algae cells 14 from a solvent source 18.

The concentrated algae cells 14 together with the lipid-extracting solvent are then typically fed into a sonicator or static mixer 20 to increase the effectiveness of the extraction, and resulting in the extraction of lipid from the oleaginous algae to form extracted algae and lipid. If sonicated, the algae cells should be sonicated only briefly (e.g., for a few seconds) at a frequency from about 20 kHz to 1 MHz, with frequencies of 20 KHz to 60 KHz being preferred. The solvent including the lipid and the extracted algae are then diverted to a partition chamber 22 in which the lower aqueous phase 24 including residual algae culture medium and extracted algae is separated from the upper organic phase 26 that includes the lipid-extracting solvent and the lipid. The lower aqueous phase 24 is returned to the algae culture source 10 and the upper organic phase 26 is provided to a lipid purifying device 28 such as a distillation apparatus. Purified lipid-extracting solvent is then returned to the solvent source 18, while the extracted lipid is provided to a collector 30.

Rather than applying sonication separately, in some embodiments of the invention the acoustic focusing device can be tuned to a frequency that destabilizes the cellular plasma membrane and helps to loosen the cell wall structure such that the sonication or static mixing steps can be taken out of the system thereby reducing the cost of the process. This can be achieved by either pretreatment of the cells with sonication or a second acoustic focusing step on the concentrated cells that allows removal of the majority of the cells from the treatment stream to speed up the two phase separation step in the non-destructive extraction process. Accordingly, some embodiments further include the step of sonicating the oleaginous algae at a frequency suitable to destabilize the cell wall structure before mixing the oleaginous algae with the lipid-extracting solvent, whereas other embodiments further include the step of sonicating the oleaginous algae at a frequency suitable to destabilize the cell wall structure during or after mixing the oleaginous algae with the lipid-extracting solvent.

In some embodiments of the invention, the non-destructive extraction of lipids from the oleaginous algae can be carried out under conditions that will alter the profile of lipids obtained from the algae. For instance, see Example 1, provided herein, which describes how gentle extraction using a non-destructive extraction process provides low molecular weight lipids with a profile different from that obtained using more harsh extraction methods.

The present invention refers to both oleaginous algae and algae culture. Oleaginous algae are algae species that can, under known conditions, accumulate a significant portion of its biomass as lipid. For example, embodiments of oleaginous algae are algae species that are capable of accumulating at least 10%, at least 20%, at least 30%, at least 40%, or at least 50% of their biomass as lipid. Suitable oleaginous algae species can be found in the Bacillariophyceae, Chlorophyceae, Cyanophyceae, Xanthophyceaei, Chrysophyceae, Chlorella, Crypthecodinium, Schizocytrium, Nannochloropsis, Ulkenia, Dunaliella, Cyclotella, Navicula, Nitzschia, Cyclotella, Phaeodactylum, and Thaustochytrid classes and genera. A preferred genera of oleaginous algae is Chlorella, which includes numerous species capable of accumulating about 55% of their total biomass as lipids. See for example Miao & Wu, Journal of Biotechnology, 110, p. 85-93 (2004). Suitable Chlorella species include Chlorella vulgaris, Chlorella protothecoides, Chlorella sorokiniana, and Chlorella kessleri.

The algae species used form a part of an algae culture. An algae culture refers to one or more algae species living in an environment that enables their survival and possible growth. The culture conditions required for various algae species are known to those skilled in the art. Examples of the components of an algae culture include water, carbon dioxide, minerals and light. However, the components of an algae culture can vary depending on the algae species, and whether or not conditions for autotrophic or heterotrophic growth are desired. For autotrophic growth, the algae culture will require CO₂ and light energy (e.g., sunlight), whereas heterotrophic growth requires organic substrates such as sugar for the growth of the algae culture, and can be carried out in the absence of light energy. An algae culture requires that appropriate temperature conditions be maintained, and preferably that the culture is mixed to provide even access to nutrients and/or light. While algae can grow in non-aqueous environments, algae culture as referred to herein is algae culture in an aqueous environment, and is therefore a liquid. Preferably the algae culture is a monoculture including a single algae species, or at least is intended as such, taking into account possible contaminating predators and competitors. Use of a monoculture makes it easier to provide optimal culture conditions, and can simplify growing and processing the algae in other ways. However, embodiments of the invention include algae cultures that have more than one species of algae present.

In one aspect of the invention, the method includes providing a portion of algae culture including an oleaginous algae from an algae culture source and concentrating the oleaginous algae by acoustic focusing. Typically, only a portion of the algae culture is removed to reduce the amount of lipid-extracting solvent required, to increase the effectiveness of extraction, and to minimize the additional stress on the oleaginous algae. The portions may be obtained in a continuous or non-continuous fashion, and in some embodiments the entire algae culture may be subjected to extraction. The portion of algae culture is typically obtained from algae culture that is growing or being maintained in an open pond such as a raceway type pond, or a closed system such as a photobioreactor, which is typically provided by a translucent container, that includes a light source either externally or internally.

The terms “ultrasonic standing wave” technology and “acoustic focusing” are synonymous as used herein. The application and theory behind the operation of acoustic focusing is described in U.S. Pat. No. 7,340,957, issued to Kaduchak et al., which is incorporated by reference herein. In brief, acoustic focusing uses an apparatus that delivers acoustic radiation pressure to position or concentrate analytes suspended in a fluid. The natural resonance frequency of a tube (e.g., a cylindrical tube) is used to concentrate analytes within the axial center of the tube. A transducer is attached to the tube to provide the requisite acoustic energy. The tube can be formed of a variety of materials, such as glass, plastic, metals, or crystalline solids. The transducer can include piezoceramic, piezosalt, piezopolymer, piezocrystal, magnetostrictive, or other electromagnetic transducers. An additional transducer can be provided to help tune the drive frequency and provide electronic feedback. Particles having a specific size can be focused within the center of the acoustic focusing device by using a specific frequency, which can be determined by calculation. See for example Goddard et al., Anal. Chem., 15; 79 (22), 8740-6 (2007), in which acoustic energy at 75 mW and 461.4 kHz is used to concentrate particles in a flow cytometer. In another reference by Goddard et al., (Cytometry Part A 69A, 66-74 (2006)), the use of a frequency of 417 kHz is described. The components necessary to generate an ultrasonic standing wave can be referred to herein as an acoustic focusing device.

Because of the ability of acoustic focusing to move particles of a particular size in response to the frequency used, acoustic focusing can be used for various concentrating processes useful in conjunction with the extraction of oil from oleaginous algae. For example, in some embodiments of the invention, the oleaginous algae concentrated by acoustic focusing are oleaginous algae with a high lipid content, such as mature algae. This can further increase the efficiency of the process by focusing solvent treatment only on algae cells that include a significant amount of lipid. High frequency acoustic standing waves can be used to separate materials with different acoustic impedances. The acoustic impedances are determined by the density and compressability differences between the particle and the surrounding fluid. Therefore, two particles of identical size (e.g., algae including a high lipid level, and algae that do not include high lipid levels) can be separated because they have different acoustic impedances.

In other embodiments, extraneous particulate matter can be removed from the algae culture by concentrating the particular matter by acoustic focusing and removing the concentrated particulate matter. Extraneous particular matter refers to material that is not necessary and typically undesirable in the algae culture. Extraneous particulate matter will tend to have a size that is different (larger, smaller, or both) from the oleaginous algae, and by focusing on a size other than that of the target oleaginous algae, the extraneous particular matter can be directed to a point and collected, thereby removing it from the algae culture. The extraneous particulate matter can be collected at any point in the process of extracting lipids from the oleaginous algae, or can simply be run independently as a method to enforce the purity of the algae culture. For example, extraneous particulate matter can be collected after a portion of algae culture has been taken from the algae culture source, but before the oleaginous algae cells are concentrated using acoustic focusing. Examples of extraneous particular matter are non-living cell debris and/or dissolved organic matter. Another example of extraneous particulate matter is an algae predator and/or algae competitor having a size or density different from the oleaginous algae. Algae predators (i.e., algae grazers) and/or algae competitors are further defined herein in regard to use of the non-destructive extraction process for predator control.

As shown in FIG. 1, the concentrated oleaginous algae are mixed with a lipid-extracting solvent to form an algae-solvent mixture; and the solvent-algae mixture is processed to obtain a solvent-lipid fraction and an extracted algae fraction, with optional sonication to improve the extraction. Preferably the algae cells are combined with a lipid-extracting solvent for a number of minutes in a process which has no significant effect on cell survivability. For example, the cells can be combined with a lipid extracting solvent for about 5 minutes. This extraction process is described in greater detail in U.S. Patent Publication No. 20090181438, which is incorporated herein by reference.

The purpose of stressing the oleaginous algae is to increase their production of lipids. Lipid production can be increased by varying amounts depending on the algae and the stress applied. As noted herein, the lipid context of oleaginous algae can be increased to 10%, 20%, 30%, 40%, or even 50% of the cells dry weight through the application of stress. Lipids, as defined herein, include naturally occurring fats, waxes, sterols, monoglycerides, diglycerides, triglycerides and phospholipids. The preferred lipids are triacylglycerides including three fatty acids attached to the glycerol backbone. Free fatty acids are synthesized in algae through a biochemical process involving various enzymes such as trans-enoyl-acyl carrier protein (ACP), 3-hydroxyacyl-ACP. 3-ketoacyl-ACP, and acyl-ACO. Examples of free fatty acids include fatty acids having a chain length from 14 to 20, with varying degrees of unsaturation. A variety of lipid-derived compounds can also be useful as biofuel and may be extracted from oleaginous algae. These include isoprenoids, straight chain alkanes, and long and short chain alcohols, which short chain alcohols including ethanol, butanol, and isopropanol.

A lipid-extracting solvent is an organic solvent that will take up lipids from oleaginous algae that are immersed in the solvent. Examples of lipid-extracting solvents include hydrocarbons with a length from C₄ to C₁₆, with hydrocarbons having a length of C₁₀ to C₁₆ being preferred. Examples of suitable lipid-extracting solvents include 1,12-dodecanedioic acid diethyl ether, n-hexane, n-heptane, n-octane, n-dodecane, dodecyl acetate, decane, dihexyl ether, isopar, 1-dodecanol, 1-octanol, butyoxyethoxyehteane, 3-octanone, cyclic paraffins, varsol, isoparaffins, branched alkanes, oleyl alcohol, dihecylether, and 2-dodecane. The oleaginous algae that have had their lipids removed by extraction are referred to herein as extracted algae.

### Sonically Controlled Mixing

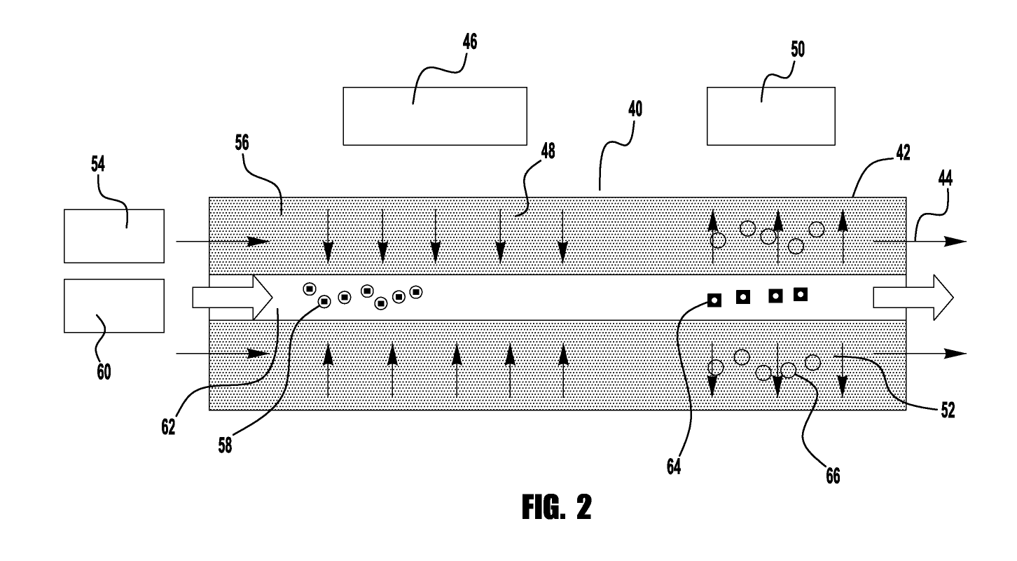

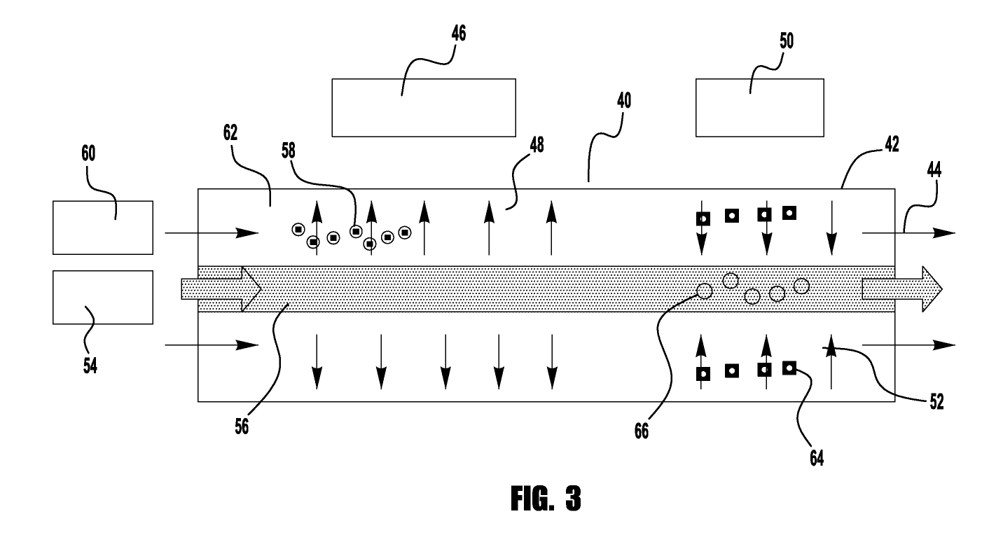

Another embodiment of the invention is depicted in FIG. 2 and FIG. 3. In this embodiment of the invention, acoustic focusing is not merely used to concentrate the oleaginous algae cells or other extraneous particulate matter, but rather is used to both concentrate the algae and move it into and out of the lipid-extracting solvent.

One aspect of the invention relates to an apparatus for extracting lipid from an oleaginous algae using acoustic focusing. FIG. 2 depicts a device 40 for extracting lipid from an oleaginous algae that includes a container 42 defining a liquid flowpath 44 therein. A first acoustic focusing device 46 is provided in operative relationship with a first treatment zone 48 in the flowpath 44. A second acoustic focusing device 50 in operative relationship with a second treatment zone 52 in the flowpath 44, the second treatment zone 52 being spaced from the first treatment zone 48. Also included are algae flow means 54 for directing the flow of a liquid algae culture 56 including an oleaginous algae 58 along the flowpath 44. Solvent flow means 60 for directing the flow of a lipid-extracting solvent 62 along the flowpath 44 in a manner so that the liquid algae culture 56 and the lipid-extracting solvent 62 contact one another without substantial mixing.

The first acoustic focusing device 46 is structured to cause the oleaginous algae 58 to move out of the liquid algae culture 56 and into the lipid-extracting solvent 62 in the first treatment zone 48 for extracting lipid 64 from the oleaginous algae 58, thereby releasing lipid 64 into the lipid extracting solvent 62 and converting the oleaginous algae 58 to extracted algae 66. The oleaginous algae are sonically mixed when moved into the lipid-extracting solvent. Sonic energy may be varied to lyse or thoroughly agitate the oleaginous algae cells to facilitate extraction of the lipid. The second acoustic focusing device 50 is structured to cause extracted algae 66 to move out of the lipid-extracting solvent 62 and back into the liquid algae culture 56 in the second treatment zone 52. As described further herein, this movement may be caused by forming an anti-node within apparatus.

Accordingly, FIG. 2 provides an embodiment of the invention in which the lipid-extracting solvent flow is within the flow of the liquid algae culture. FIG. 3, on the other hand, provides a reverse embodiment, in which the liquid algae culture flow is within the flow of the lipid-extracting solvent. For the embodiment shown in FIG. 3, the oleaginous algae 58 are therefore first pulled away from the liquid algae culture 56 running through the axial region of the flowpath into the lipid-extracting solvent 62, and the extracted algae 66 are subsequently moved back from the lipid-extracting solvent 62 in the outer region of the flowpath 44 and into the liquid algae culture 56 moving through the axial region of the flowpath 44. Upon leaving the apparatus, the lipid-extracting solvent can be further processed to regenerate the solvent and obtain the lipid, as described herein, and the liquid algae culture can be returned to the algae culture source. Because the two liquids are not significantly mixed, haze and emulsion formation are reduced and it should not be necessary to conduct a partitioning step.

The acoustic focusing devices are structured to be able to direct the oleaginous algae into different regions of a treatment zone within the flowpath. Structured, as used herein, means that the focusing devices are constructed and tuned to provide the desired result of moving the oleaginous algae within the flowpath. For example, if the flowpath is provided within a cylindrical container, acoustic focusing devices can move the oleaginous algae to or away from the axial region within the flowpath. As described herein, a frequency for applying acoustic energy can be determined that will move particles of a specific size. Those skilled in the art can readily calculate the frequency appropriate for moving oleaginous algae to various regions within the flowpath. In addition to moving particles of a specific size towards an axial region of a flowpath, which can also be referred to as a node, acoustic focusing can also be used to move particles of a specific size away from the axial region of a flowpath towards an outer region of the flowpath. In this case, the axial region of the flowpath can be referred to as an anti-node.

The acoustic focusing devices are also described as being in operative relationship with a treatment zone. A treatment zone is a region within the flowpath of the apparatus where acoustic energy is applied to move the particles (e.g., oleaginous algae) either to or from the lipid-extracting solvent. Being in operative relationship indicates that the acoustic focusing device is positioned appropriately on the device to move particles within the corresponding treatment zone. For example, in a cylindrical flowpath, a cylindrical acoustic focusing device may be positioned around the exterior of the device to move particles (e.g., oleaginous algae) within the portion of the flowpath that is encompassed by the acoustic focusing device.

The liquid algae culture and the lipid-extracting solvent contact one another without substantial mixing. Accordingly, flow through the device is essentially laminar. This is due in part to the essentially immiscible nature of the organic and hydrophobic lipid-extracting solvent and the liquid algae culture, which is aqueous and hydrophilic. However, embodiments of the invention can include a third acoustic focusing device to apply acoustic energy at a frequency effective to retain either the liquid algae culture or the lipid-extracting solvent within an axial region of the flowpath. In some embodiments, keeping the solvent or the liquid algae culture in the axial region of the apparatus may require application of multiple ultrasonic frequencies.

The focusing of an axial layer of liquid can be explained as follows. Once the solvent droplet mixes with the algal culture, it forms micelles or emulsions on a larger scale, because there are components in the algal culture that stabilize the solvent-water interface like proteins and other cell debris. In this case, the micelle of solvent can be manipulated by sonic radiation pressure because there is contrast (density and compressibility difference) between the micelle and the surrounding fluid.

The apparatus also includes algae flow means for directing the flow of a liquid algae culture and solvent flow means for directing the flow of a lipid-extracting solvent along the flowpath. Flow means can include pumps and associated tubing to provide liquid algae culture and lipid-extracting solvent to entry points on the apparatus from appropriate sources (e.g., an algae pond for the liquid algae culture), or other means of moving a liquid such as impelling the liquid using gravity.

Various different embodiments of the invention are encompassed by the description of the apparatus provided above. For example, in some embodiments, more than two acoustic focusing devices structured to cause further movement of the extracted algae into and out of the lipid-extracting solvent in additional treatment zones can be provided in order to carry out more than two focusing and defocusing steps to increase the amount of mixing and stimulate the release of lipid from the algae cells. For example, the apparatus can include 4 or 6 acoustic focusing devices to repeatedly move the oleaginous algae into and out of the lipid-extracting solvent, in which case the apparatus would have 4 or 6 treatment zones, respectively. The acoustic focusing devices would typically be added in pairs so that the extracted algae will end up in the liquid algae culture before removal of the liquid algae culture from the apparatus.

In another aspect, the present invention provides a method of extracting lipid from an oleaginous algae using acoustic focusing that includes the steps of providing a flow of a liquid algae culture including oleaginous algae that is in contact with but does not substantial mix with a flow of a lipid-extracting solvent; applying acoustic energy from a first acoustic focusing device to move the oleaginous algae from the flow of liquid algae culture into the flow of lipid-extracting solvent, allowing the oleaginous algae to remain in the lipid-extracting solvent for an amount of time sufficient for the lipid-extracting solvent to extract the lipid thereby converting the oleaginous algae into extracted algae; applying acoustic energy from a second acoustic focusing device to move the extracted algae from the lipid-extracting solvent to the flow of liquid algae culture; and collecting the lipid-extracting solvent that includes the extracted lipid.

The method may also include applying acoustic energy to help retain the lipid-extracting solvent and the liquid algae culture in laminar flow. In one embodiment, acoustic energy is applied by a third acoustic focusing device to retain the flow of lipid extracting solvent within the flow of the liquid algae culture, while in another embodiment acoustic energy is applied by a third acoustic focusing device to retain the flow of liquid algae culture within the flow of lipid-extracting solvent.

The method may also include varying the frequency to alter the nature of the particles being moved. For example, in one embodiment, the acoustic energy applied from the first acoustic focusing device has a frequency suitable for moving mature oleaginous algae with a high lipid content. This can be done to carry out solvent extraction on only those cells with a high lipid-content, while the oleaginous algae with lower lipid content remain in the liquid algae culture.

Finally, the method can also include sonicating the oleaginous algae. The algae can be sonicated at various points in the process. For example, it may be preferable to pre-treat the algae by sonication before they are moved by acoustic focusing. Alternately, the oleaginous algae may be sonicated as they remain in the lipid-extracting solvent. Sonication may be carried out by varying the frequency of the acoustic focusing devices that are moving the oleaginous algae, or it can be applied by acoustic focusing devices that are provided specifically for the purpose of providing sonication energy. Sonication differs from acoustic focusing in that it does not result in the directional movement of the oleaginous algae, but rather simply vibrates the oleaginous algae in a random fashion.

### Sonically Controlled Separation of Specific Algae Culture Constituents

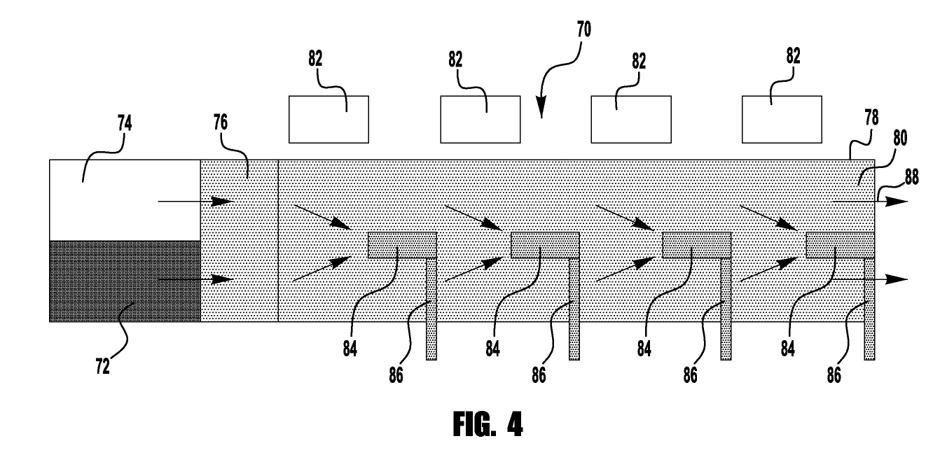

FIG. 4 provides a schematic view of a separating apparatus 70 for extracting oleaginous algae in which various different constituents are extracted using ultrasonic focusing. The apparatus 70 includes means for providing a flow of liquid algae culture 72 and a means for providing a flow of lipid-extracting solvent 74. The liquid algae culture and the lipid-extracting solvent are directed into a mixing region 76 in which the two liquids are mixed by suitable mixing means such as mechanical mixing or sonication. The combined liquid algae culture and the lipid-extracting solvent then pass through a container 78 defining a flowpath 80.

Subsequent to entering the flowpath 80, particles having a variety of different sizes are acoustically focused by acoustic focusing devices 82 positioned in operative relationship with adjacent treatment zones. Acoustic focusing will concentrate particles of a size dependent on the frequency used to an axial region of the flowpath 80 where a collector 84 is positioned to receive the concentrated particles. The concentrated particles are then directed out of the separating apparatus 70 from the collector through a particle outlet 86. Separation is achieved due to size of the constituent and USW wave parameter. The sonic energy can be tuned for particular acoustic focusing devices to concentrate various types of particles, such as live algae, extraneous particulate matter such as dead algae or algae predators, and solvents. The constituent collected by a particular collector 84 is dependent on the acoustic parameters and dimensions of device. Any material not separated by application of acoustic focusing will then leave the separating apparatus 70 through a general outlet 88. For example, mixed liquid algae culture and lipid-extracting solvent may flow out of the general outlet for separation by partitioning. In the methods and apparatus of the invention, the transducers can be attached to the flowpath container (i.e., a vessel) and the coupling of the transducer to the vessel and the dimensions of the vessel generate the standing waves. One can apply acoustic focusing from a single acoustic focusing device to separate different particles at different points through the device. To carry this out, multiple transducers are operated, as well as multiple frequencies in each transducer by using frequency modulation.

Focusing of living algae using ultrasonic standing wave technology to separate them from non-living cell debris and dissolved organic matter (DOM) is useful because debris and DOM reflect and absorb sunlight, effectively reducing the maximum working depth of an algae culture pond. Therefore, removing this debris may assist in allowing greater pond depth or at the very least by reducing the respiration activity by bacteria/fungi working on metabolizing DOM. Using the USW approach, algae cells can be concentrated or focused based on size and density such that only target algae species (e.g., Nannochloropsis or Chlorella size cells) are returned to the algae culture ponds, while streams of larger (e.g., rotifers, predators, fungi, competitive algae species) and smaller cells (e.g., bacteria, and viruses) are diverted elsewhere. This would effectively remove undesirable biological contaminants in the ponds, and reduce biomass losses resulting from nutrient competition.

Predator Control from Non-Destructive Extraction

In another aspect, the present invention provides a method of reducing the levels of predators and/or competitors in a culture of an oleaginous organism species by carrying out a non-destructive extraction of the culture. The target algae species refers to the species that is intentionally being cultured, as opposed to competitor algae species that may have invaded the culture. The present invention provides a method of reducing the levels of algae predators and/or algae competitors in an algae culture of a target algae species by carrying out a non-destructive extraction of an algae culture. Note that while the process is referred to as non-destructive, in this context that is only with regard to the target species, and not the algae predators and/or competitors that are being reduced in number or eliminated by the process.

A target algae species is an alga species that is intentionally being cultured, as opposed to competitor algae species that may have invaded the culture. In some embodiments, the culture may include more than one target algae species if more than one species are being co-cultured. Examples of target algae species include any of the oleaginous algae species described herein, such as Nannochloropsis and Chlorella. Target algae species are preferably species that have an existing resistance to the non-destructive extraction process, or that have developed such resistance over time. While use of a full non-destructive extraction process is preferred for predator control, in some embodiments of the invention, ultrasonic energy can be used in isolation to reduce predator viability in a contaminated algae culture without harm to the target algae species.

Embodiments of the invention can provide various levels of reduction of the levels of algae predators or competitors. For example, the method can reduce algae predators or competitors by any amount from about 10 to about 100%, including about 20%, 30%, 40%, 50%, 60%, 70%, 80%, 90%, and about 100%. In some embodiments, the levels of algae predators may be reduced by a higher amount than the levels of algae competitors. For example, algae predators may be reduced by about 100%, while algae competitors are reduced by only about 50%.

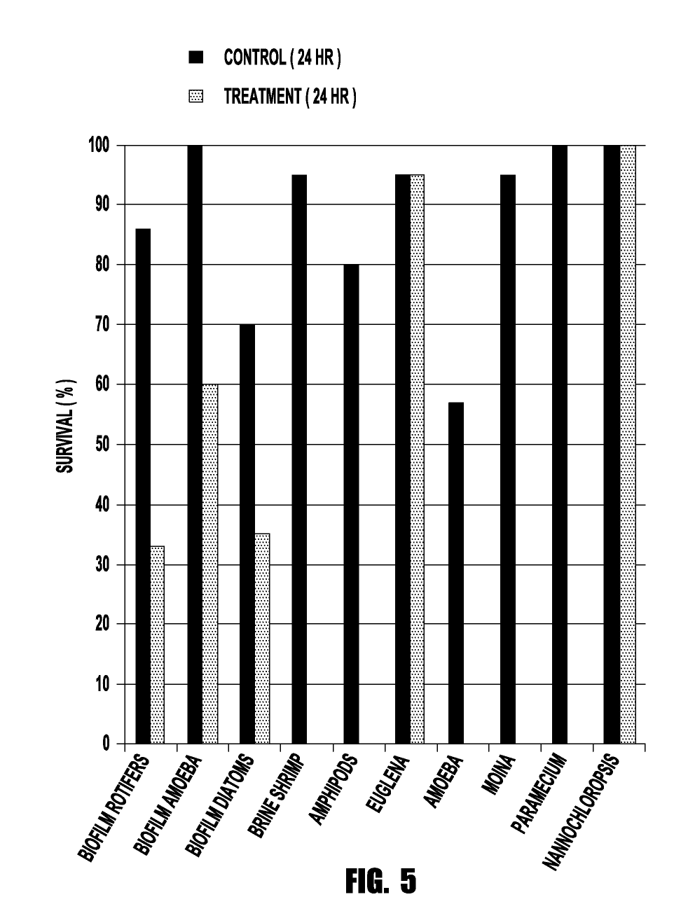

Open cultures of algae attract and support large numbers of algal predators which, when untreated, significantly reduce the algae concentrations possible in an algae production system or pond. The non-destructive extraction process continuously reduces the impact of predators by destroying or impairing the viability of algal predators. FIG. 5 shows the effect of non-destructive extraction on the viability of various algae predators and competitors, with a control showing the level of survival of cells not subjected to this process, as compared with the level of survival of organisms treated with the non-destructive extraction process including sonication. Note that the non-destructive extraction process completely killed all of the brine shrimp, amphipods, amoeba, Moina, and Paramecium so the survival percentages upon treatment for these species are zero.

The method of algae predator control includes mixing at least a portion of the algae culture with a lipid-extracting solvent to obtain a solvent-algae mixture; separating the solvent-algae mixture to obtain a solvent-lipid fraction and an extracted algae fraction that includes a decreased level of algae predators and/or algae competitors and a relatively unaffected level of target algae species; and returning the extracted algae fraction to the algae culture. In some embodiments, the algae culture and lipid-extracting solvent are sonicated during mixing. For example, the algae culture can be sonicated at about 10 to about 100 kHz.

A variety of solvents can be used for algae predator control. Essentially all of the solvents described herein for use in the non-destructive extraction process may be used. For example, in one embodiment, the lipid-extracting solvent has a log P_{octanol} value of greater than or equal to 6, while in another embodiment the lipid-extracting solvent is gasoline, isoparaffins, decane, dodecane, or undecane.

Algae predators can include, but are not limited to, protozoans (e.g., amoeboids, ciliates, and euglenoids), insects and their larvae, and animal invertebrates (e.g., rotifers and crustaceans). Algae competitors include non-target algae species, such as diatoms. For example, in one embodiment of the invention, the algae predators and/or algae competitors are selected from the group consisting of protozoa, bacteria, viruses, yeast, crustaceans, insect larvae, amoeba, diatoms and other non-target algae species. Algae predators that are particularly strongly reduced by this process include brine shrimp, amphipods, amoeba, Moina, and Paramecia. This is helpful because ciliates and amoeba are particularly common algae predators in freshwater algae cultures. Additional embodiments can be directed only to the removal of algae predators, rather than the removal of algae predators and algae competitors.

In addition to the resistance of the target algae species, other factors are also responsible for the ability to differentially affect the algae predators and competitors in an algae culture. Since the acoustic impedances are determined by the density and compressibility differences between the particle and the surrounding fluid, a competitor algae can be selected by their predominate cellular contents, cell wall etc. Other factors that can be used to distinguish the algae competitors include whether or not lipid is present, or if SiO₂ is present (for diatoms).

An example has been included to more clearly describe a particular embodiment of the invention and its associated cost and operational advantages. However, there are a wide variety of other embodiments within the scope of the present invention, which should not be limited to the particular example provided herein.

### EXAMPLE

### Example 1

### Gentle Extraction Using a Non-Destructive Extraction Process Provides Low Molecular Weight Lipid Class that is Not Reflective of More Harsh Extraction Methods

Nannochloropsis sp., a unicellular alga capable of producing large amounts of triacylglycerides, was grown in f/2 medium with ⅓^{rd} strength Instant Ocean under indoor lighting in 800 L raceway systems either kept moving with a submerged pump or paddlewheel. Once the culture was greater than 0.5 g/L dry weight, the cells were circulated through the non-destructive extraction process (NDEP) but only briefly sonicated. This sonication is described in the Sayre patent (U.S. patent application Ser. No. 12/328,695). These low energy extraction conditions resulted in surprising lipid profiles when compared to cells that had undergone either hexane extraction or more rigorous non-destructive extraction using decane.

TABLE 1
Comparison of fatty acid profiles of algae extracted with high levels of
energy under NDEP or low levels of energy under NDEP compared
with standard hexane extraction.

| | NDEP Hi | NDEP LO | Standard |
|---|---|---|---|
| FA | decane | decane | hexane |
| C6 or less | 0 | 21.44 | 5.74 |
| C8 | 0 | 54.63 | 0.51 |
| C10 & C12 | 0 | 1.74 | 1.74 |
| C14 | 3.1 | 0 | 5.01 |
| C16 | 39.7 | 0.61 | 19.74 |
| C17-20 | 57.3 | 9.32 | 59.62 |
| C21 and up | 0 | 12.26 | 8 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of concentrating and extracting lipid from oleaginous algae in an algae culture, comprising
providing a portion of algae culture including an oleaginous algae from an algae culture source;
concentrating the oleaginous algae by acoustic focusing;
mixing the concentrated oleaginous algae with a lipid-extracting solvent to form an algae-solvent mixture; and
separating the solvent-algae mixture to obtain a solvent-lipid fraction and an extracted algae fraction.

2. The method of claim 1, further comprising returning the extracted algae fraction to the algae culture source.

3. The method of claim 1, wherein the oleaginous algae concentrated by acoustic focusing are oleaginous algae with a high lipid content.

4. The method of claim 1, further comprising sonicating the oleaginous algae at a frequency suitable to destabilize the cell wall structure before mixing the oleaginous algae with the lipid-extracting solvent.

5. The method of claim 1, further comprising sonicating the oleaginous algae at a frequency suitable to destabilize the cell wall structure during or after mixing the oleaginous algae with the lipid-extracting solvent.

6. The method of claim 1, further comprising removing extraneous particulate matter from the algae culture by concentrating the particular matter by acoustic focusing and removing the concentrated particulate matter from the algae culture.

7. The method of claim 6, wherein the extraneous particulate matter is non-living cell debris and/or dissolved organic matter.

8. The method of claim 6, wherein the extraneous particulate matter is an algae predator and/or algae competitor having a size or density different from the oleaginous algae.

9. A device for extracting lipid from an oleaginous algae, comprising:
a container defining a liquid flowpath therein;
a first acoustic focusing device in operative relationship with a first treatment zone in the flowpath;
a second acoustic focusing device in operative relationship with a second treatment zone in the flowpath, the second treatment zone being spaced from the first treatment zone;
algae flow means for directing the flow of a liquid algae culture including an oleaginous algae along the flowpath;
solvent flow means for directing the flow of a lipid-extracting solvent along the flowpath in a manner so that the liquid algae culture and the lipid-extracting solvent contact one another without substantial mixing;
wherein the first acoustic focusing device is structured to cause the oleaginous algae to move out of the liquid algae culture and into the lipid-extracting solvent in the first treatment zone for extracting lipid from the oleaginous algae, thereby releasing lipid into the lipid extracting solvent and converting the oleaginous algae to extracted algae, and further
wherein the second acoustic focusing device is structured to cause extracted algae to move out of the lipid-extracting solvent and back into the liquid algae culture in the second treatment zone.

10. The device of claim 9, wherein the lipid-extracting solvent flow is within the flow of the liquid algae culture.

11. The device of claim 9, wherein the liquid algae culture flow is within the flow of the lipid-extracting solvent.

12. The device of claim 9, wherein the device further comprises a third acoustic focusing device to apply acoustic energy at a frequency effective to retain either the liquid algae culture or the lipid-extracting solvent within an axial region of the flowpath.

13. The device of claim 9, wherein additional acoustic focusing devices are included that are structured to cause further movement of the extracted algae into and out of the lipid-extracting solvent in additional treatment zones.

14. A method of extracting lipid from an oleaginous algae using acoustic focusing comprising:
providing a flow of a liquid algae culture including oleaginous algae that is in contact with but does not substantial mix with a flow of a lipid-extracting solvent;
applying acoustic energy from a first acoustic focusing device to move the oleaginous algae from the flow of liquid algae culture into the flow of lipid-extracting solvent, allowing the oleaginous algae to remain in the lipid-extracting solvent for an amount of time sufficient for the lipid-extracting solvent to extract the lipid thereby converting the oleaginous algae into extracted algae;
applying acoustic energy from a second acoustic focusing device to move the extracted algae from the lipid-extracting solvent to the flow of liquid algae culture; and
collecting the lipid-extracting solvent that includes the extracted lipid.

15. The method of claim 14, wherein acoustic energy is applied by a third acoustic focusing device to retain the flow of lipid extracting solvent within the flow of the liquid algae culture.

16. The method of claim 14, wherein acoustic energy is applied by a third acoustic focusing device to retain the flow of liquid algae culture within the flow of lipid-extracting solvent.

17. The method of claim 14, wherein the acoustic energy applied from the first acoustic focusing device has a frequency suitable for moving mature oleaginous algae with a high lipid content.

18. The method of claim 14, further comprising sonicating the oleaginous algae as they remain in the lipid-extracting solvent.

19. A method of reducing the levels of algae predators and/or algae competitors in an algae culture of a target algae species, comprising
mixing at least a portion of the algae culture with a lipid-extracting solvent to obtain a solvent-algae mixture;
separating the solvent-algae mixture to obtain a solvent-lipid fraction and an extracted algae fraction that includes a decreased level of algae predators and/or algae competitors and a relatively unaffected level of target algae species; and
returning the extracted algae fraction to the algae culture.

20. The method of claim 19, wherein the algae culture and lipid-extracting solvent are sonicated during mixing.

21. The method in claim 19, wherein the lipid-extracting solvent has a log P_{octanol} value of greater than or equal to 6.

22. The method in claim 21, wherein the lipid-extracting solvent is gasoline, isoparaffins, decane, dodecane, or undecane.

23. The method of claim 19, wherein the algae predators and/or algae competitors are selected from the group consisting of protozoa, bacteria, viruses, yeast, crustaceans, insect larvae, amoeboids, diatoms and other non-target algae species.
